(19) United States
(12) Patent Application Publication
(10) Pub. No.: US 2005/0152539 A1
(43) Pub. Date: Jul. 14, 2005

(54) Method of protecting cryptographic operations from side channel attacks

(76) Inventor: Ernie F. Brickell, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/756,596

(22) Filed: Jan. 12, 2004

(51) Int. Cl. H04K 1/00

(52) U.S. Cl. 380/28

(57) ABSTRACT

Deterring side channel attacks on cryptographic computations using an exponent value e and a modulus value n to determine a result value may be accomplished by picking a first value, picking a second value, computing a third value as a product of the first and second values mod n, computing a first intermediate value as the first value to the exponent e mod n, computing a second intermediate value as the second value to the exponent e mod n, and computing a result value equal to the third value to the exponent e mod n as the product of the first intermediate value and the second intermediate value mod n. The result value y^{e} mod n may be determined in this manner without using a modular inverse operation.

### BACKGROUND

1. Field

The present invention relates generally to cryptography and, more specifically, to deterring attacks based at least in part on observing cryptographic computations in a processing system.

2. Description

Public key cryptography is well-known and widely used today. In public key cryptography, each user has a public key and a private key. The public key is made public, while the private key remains secret. Encryption is performed with the public key, while decryption is done with the private key.

The most popular form of public key cryptography today is the Rivest, Shamir, Adleman (RSA) public key cryptosystem. Key generation in the RSA algorithm works as follows: take two large primes, p and q, and compute their product n=p*q; n is called the modulus. Choose a number, called the encryption exponent e, less than n and relatively prime to (p−1)*(q−1), which means e and (p−1)*(q−1) have no common factors except 1. Find another number, called the decryption exponent d, such that (e*d−1) is divisible by (p−1)*(q−1). The values e and d are also called the public and private exponents, respectively. The public key is the pair (n, e) and the private key is the exponent d. The factors p and q may be destroyed or kept with the private key.

Encryption and decryption may be performed as follows. Suppose Alice wants to send a plaintext message m (0≦m≦n−1) to Bob. Alice creates the ciphertext message c (0≦c≦n−1) by exponentiating c=m^{e} mod n, where e and n are Bob's public key. She sends c to Bob. To decrypt, Bob exponentiates m=c^{d} mod n; the relationship between e and d ensures that Bob correctly recovers m. Since only Bob knows d, only Bob can decrypt this message.

Attacks on the RSA system have been attempted. In some sophisticated attack scenarios, d or other values may inferred from information gathered from observing a processing system performing the modular exponentiation operation. In these scenarios, observing power utilization, memory access patterns, cache line accesses, and/or branches taken in executing code within the processing system may give the attacker sufficient information to deduce the private key. Hence, obscuring cryptographic computations such that observation of the power utilization, memory access patterns, cache line accesses, and/or branches taken in executing code while performing the computations provides no meaningful information to an attacker is desirable.

### BRIEF DESCRIPTION OF THE DRAWINGS

The features and advantages of the present invention will become apparent from the following detailed description of the present invention in which:

FIG. 1 is a diagram illustrating a known processing system (Prior Art); and

FIG. 2 is a flow diagram illustrating a process for protecting cryptographic operations according to an embodiment of the present invention.

### DETAILED DESCRIPTION

An embodiment of the present invention is a method of deterring “side channel” attacks on cryptographic computations such that an attacker can gain no meaningful information by observing, for example, power utilization, memory access patterns, cache line accesses, or code branches of a processing system.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

Cryptographic operations performed in a processing system have been observed and security has been compromised by side channel attacks. A side channel attack is an attack that gains information from the processing system's hardware that reveal secrets involved in the cryptographic operations. One example of a side channel attack is a timing attack, in which the adversary obtains information about the secret from the length of time needed to perform a cryptographic operations or a step in a cryptographic operation. Another example is a power analysis attack, where the adversary obtains information from observing the graph of the power used by a hardware device while that device is computing a cryptographic operation.

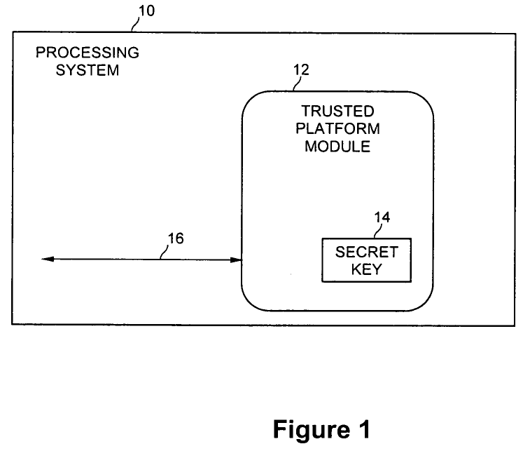

FIG. 1 is a diagram of an example known processing system 10. In this system, a security component such as a trusted platform module (TPM) 12, is included to perform at least some of the cryptographic operations for the system. In FIG. 1, other system components are omitted for clarity. The TPM may include secret information, such as a secret key 14, for example. An attacker may attempt to deduce the secret key based on observation of a communications line 16 coupled to the TPM within the system. Although the secret key is not communicated on the line, observation of power consumption, memory access, or other data may provide the attacker with clues as to the value of the secret key.

A common cryptographic operation is the computation of y^{e} mod n, where exponent e and modulus n are publicly known variables, and y is a secret (such as the secret key 14). Side channel attacks may be used to attack this operation, especially where the well known Montgomery multiplication algorithm is used, because the time taken by the Montgomery multiplication is dependent on the secret value y. One known method for protecting against these attacks is to pick a random value x and compute z=y*x⁻¹ mod n, so that y=x*z mod n. The value y^{e} mod n is then computed by computing x^{e} mod n and z^{e} mod n, and then computing y^{e}=x^{e}*z^{e} mod n. These computations may be performed in the TPM. These computations mitigate the effect of side channel attacks, but require a modular inverse operation (x⁻¹ mod n) which may take a substantially longer period of processing time than exponentiation for a small e. This disadvantage may be significant for some applications and processing systems.

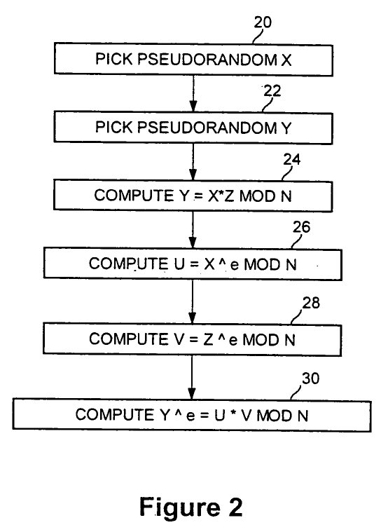

To overcome this disadvantage, embodiments of the present invention mitigate the effect of side channel attacks, but remove the need to perform a modular inverse operation. There are some cryptographic protocols in which the computation of y^{e} mod n is performed for a pseudo-randomly chosen y. At least one embodiment of the present invention makes use of this fact as shown in FIG. 2. At block 20, a processing module within the processing system (such as the TPM, for example) picks a first pseudo-random value x with substantially uniform distribution. At block 22, the processing module picks a second pseudo-random value z with substantially uniform distribution. Next, at block 24, the processing module computes a third value y=x*z mod n. If x and z have been chosen with substantially uniform distribution, then y will have a substantially uniform distribution. In one embodiment, the computation of y may be omitted. At block 26, the processing module computes a first intermediate value u=x^{e} mod n. At block 28, the processing module computes a second intermediate value v=z^{e} mod n. Finally, at block 30, the processing module computes the result value y^{e}=u*v mod n, using the first and second intermediate values, the exponent, and the modulus. This is the same as y^{e} mod n, and the method does not involve a modular inverse operation.

A side channel attack during the computation of x^{e} may reveal some information about x, and a side channel attack during the computation of z^{e} may reveal some information about z. However, the multiplication of x*z would tend to diffuse the information learned about x and z individually, making it difficult to deduce any information about y.

The present invention is faster than the prior art method that requires a modular inverse operation. It is typical to have a small value for e, such as e=17. Cryptographic hardware in a processing system is typically not optimized for the modular inverse function, and so it may take as much as 100 times as long to perform the modular inverse operation as compared to the exponentiation operation for a small e. Thus, mitigating side channel attacks using the modular inverse method would have a negative impact of two orders of magnitude on processing performance. However, embodiments of the present invention may have a negative impact on performance of only a factor of two.

Although the operations describe herein may be described as a sequential process, some of the operations may in fact be performed in parallel or concurrently. In addition, in some embodiments the order of the operations may be rearranged without departing from the spirit of the invention.

The techniques described herein are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, set top boxes, cellular telephones and pagers, and other electronic devices, that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various computer system configurations, including multiprocessor systems, minicomputers, mainframe computers, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations (such as a “smart card”, for example), or by any combination of programmed computer components and custom hardware components. The methods described herein may be provided as a computer program product that may include a machine readable medium having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

1. A method of deterring side channel attacks on cryptographic computations using an exponent value e and a modulus value n to determine a result value comprising:
picking a first value;
picking a second value;
computing a third value as a product of the first and second values mod n;
computing a first intermediate value as the first value to the exponent e mod n;
computing a second intermediate value as the second value to the exponent e mod n; and
computing a result value equal to the third value to the exponent e mod n as the product of the first intermediate value and the second intermediate value mod n.

2. The method of claim 1, further comprising picking the first value pseudo-randomly with a substantially uniform distribution.

3. The method of claim 1, further comprising picking the second value pseudo-randomly with a substantially uniform distribution.

4. The method of claim 1, wherein the exponent e and the modulus n are publicly known values, and the third value is secret.

5. An article comprising: a storage medium having a plurality of machine readable instructions, wherein when the instructions are executed by a processor, the instructions provide for deterring side channel attacks on cryptographic computations using an exponent value e and a modulus value n to determine a result value by picking a first value, picking a second value, computing a third value as a product of the first and second values mod n, computing a first intermediate value as the first value to the exponent e mod n, computing a second intermediate value as the second value to the exponent e mod n, and computing a result value equal to the third value to the exponent e mod n as the product of the first intermediate value and the second intermediate value mod n.

6. The article of claim 5, further comprising instructions for picking the first value pseudo-randomly with a substantially uniform distribution.

7. The article of claim 5, further comprising instructions for picking the second value pseudo-randomly with a substantially uniform distribution.

8. The article of claim 5, wherein the exponent e and the modulus n are publicly known values, and the third value is secret.

9. A method of deterring side channel attacks on cryptographic computations using an exponent value e and a modulus value n to determine a result value comprising:
picking a first value;
picking a second value;
computing a first intermediate value as the first value to the exponent e mod n;
computing a second intermediate value as the second value to the exponent e mod n; and
computing a result value as the product of the first intermediate value and the second intermediate value mod n.

10. The method of claim 9, further comprising picking the first value pseudo-randomly with a substantially uniform distribution.

11. The method of claim 9, further comprising picking the second value pseudo-randomly with a substantially uniform distribution.

12. An article comprising: a storage medium having a plurality of machine readable instructions, wherein when the instructions are executed by a processor, the instructions provide for deterring side channel attacks on cryptographic computations using an exponent value e and a modulus value n to determine a result value by picking a first value, picking a second value, computing a first intermediate value as the first value to the exponent e mod n, computing a second intermediate value as the second value to the exponent e mod n, and computing a result value as the product of the first intermediate value and the second intermediate value mod n.

13. The article of claim 12, further comprising instructions for picking the first value pseudo-randomly with a substantially uniform distribution.

14. The article of claim 12, further comprising instructions for picking the second value pseudo-randomly with a substantially uniform distribution.
